(19) United States
(12) Patent Application Publication
(10) Pub. No.: US 2009/0274521 A1
(43) Pub. Date: Nov. 5, 2009

(54) SYSTEMS AND METHODS FOR SELECTION OF SUPPRESSION DEVICES

(76) Inventors: Donald Wayne ALLEN, Richmond, TX (US); Dean Leroy Henning, Needville, TX (US); Li Lee, Houston, TX (US)

Correspondence Address: SHELL OIL COMPANY, P O BOX 2463, HOUSTON, TX, 772522463, US

(21) Appl. No.: 12/337,769

(22) Filed: Dec. 18, 2008

Related U.S. Application Data
(60) Provisional application No. 61/049,528, filed on May 1, 2008.

(51) Int. Cl. F15D 1/10

(52) U.S. Cl. 405/212

(57) ABSTRACT

method for determining a vortex induced vibration (VIV) suppression device configuration for a structure, comprising determining one or more technical parameters of the structure; determining VIV suppression performance for at least 2 different VIV suppression devices; determining installation and manufacturing or purchase costs of the at least 2 different VIV suppression devices; determining future costs for the at least 2 different VIV suppression devices; calculating total costs for the at least 2 different VIV suppression devices; and selecting a device with the lowest total costs that meets a desired level of VIV suppression for the technical parameters.

This application claims the benefit of U.S. Provisional Application No. 61/049,528, filed May 2, 2008, which is incorporated herein by reference.

### FIELD OF THE INVENTION

The present invention relates to systems and methods for reducing drag and/or vortex-induced vibration (“VIV”) of a structure.

### DESCRIPTION OF THE RELATED ART

Whenever a bluff body, such as a cylinder, experiences a current in a flowing fluid environment, it is possible for the body to experience vortex-induced vibration (VIV). These vibrations may be caused by oscillating dynamic forces on the surface, which can cause substantial vibrations of the structure, especially if the forcing frequency is at or near a structural natural frequency.

Drilling for and/or producing hydrocarbons or the like from subterranean deposits which exist under a body of water exposes underwater drilling and production equipment to water currents and the possibility of VIV. Equipment exposed to VIV includes structures ranging from the smaller tubes of a riser system, anchoring tendons, or lateral pipelines to the larger underwater cylinders of the hull of a mini spar or spar floating production system (hereinafter “spar”).

The magnitude of the stresses on the riser pipe, tendons or spars may be generally a function of and increases with the velocity of the water current passing these structures and the length of the structure.

It is noted that even moderate velocity currents in flowing fluid environments acting on linear structures can cause stresses. Such moderate or higher currents may be readily encountered when drilling for offshore oil and gas at greater depths in the ocean or in an ocean inlet or near a river mouth.

Drilling in ever deeper water depths requires longer riser pipe strings which, because of their increased length and subsequent greater surface area, may be subject to greater drag forces which must be resisted by more tension. This is believed to occur as the resistance to lateral forces due to the bending stresses in the riser decreases as the depth of the body of water increases.

Accordingly, the adverse effects of drag forces against a riser or other structure caused by strong and shifting currents in these deeper waters increase and set up stresses in the structure which can lead to severe fatigue and/or failure of the structure if left unchecked.

There are generally two kinds of current-induced stresses in flowing fluid environments. The first kind of stress may be caused by vortex-induced alternating forces that vibrate the structure (“vortex-induced vibrations”) in a direction perpendicular to the direction of the current. When fluid flows past the structure, vortices may be alternately shed from each side of the structure. This produces a fluctuating force on the structure transverse to the current. If the frequency of this harmonic load is near the resonant frequency of the structure, large vibrations transverse to the current can occur. These vibrations can, depending on the stiffness and the strength of the structure and any welds, lead to unacceptably short fatigue lives. In fact, stresses caused by high current conditions in marine environments have been known to cause structures such as risers to break apart and fall to the ocean floor.

The second type of stress may be caused by drag forces, which push the structure in the direction of the current due to the structure's resistance to fluid flow. The drag forces may be amplified by vortex-induced vibration of the structure. For instance, a riser pipe that is vibrating due to vortex shedding will generally disrupt the flow of water around it more than a stationary riser. This may result in more energy transfer from the current to the riser, and hence more drag.

Many types of devices have been developed to reduce vibrations and/or drag of sub sea structures. Some of these devices used to reduce vibrations caused by vortex shedding from sub sea structures operate by stabilization of the wake. These methods include use of streamlined fairings, wake splitters and flags.

Devices used to reduce vibrations caused by vortex shedding from sub-sea structures may operate by modifying the boundary layer of the flow around the structure to prevent the correlation of vortex shedding along the length of the structure. Examples of such devices include sleeve-like devices such as helical strakes, shrouds, fairings and substantially cylindrical sleeves.

Elongated structures in wind or other flowing fluids can also encounter VIV and/or drag, comparable to that encountered in aquatic environments. Likewise, elongated structures with excessive VIV and/or drag forces that extend far above the ground can be difficult, expensive and dangerous to reach by human workers to install VIV and/or drag reduction devices.

Fairings may be used to suppress VIV and reduce drag acting on a structure in a flowing fluid environment. Fairings may be defined by a chord to length ratio, where longer fairings have a higher ratio than shorter fairings. Long fairings are more effective than short fairings at resisting drag, but may be subject to instabilities. Short fairings are less subject to instabilities, but may have higher drag in a flowing fluid environment.

U.S. Pat. No. 6,223,672 discloses an ultrashort fairing for suppressing vortex-induced vibration in substantially cylindrical marine elements. The ultrashort falling has a leading edge substantially defined by the circular profile of the marine element for a distance following at least about 270 degrees thereabout and a pair of shaped sides departing from the circular profile of the marine riser and converging at a trailing edge. The ultrashort fairing has dimensions of thickness and chord length such that the chord to thickness ratio is between about 1.20 and 1.10. U.S. Pat. No. 6,223,672 is herein incorporated by reference in its entirety.

U.S. Pat. No. 4,398,487 discloses a fairing for elongated elements for reducing current-induced stresses on the elongated element. The fairing is made as a stream-lined shaped body that has a nose portion in which the elongated element is accommodated and a tail portion. The body has a bearing connected to it to provide bearing engagement with the elongated element. A biasing device interconnected with the bearing accommodates variations in the outer surface of the elongated element to maintain the fairing's longitudinal axis substantially parallel to the longitudinal axis of the elongated element as the fairing rotates around the elongated element. The fairing is particularly adapted for mounting on a marine drilling riser having flotation modules. U.S. Pat. No. 4,398,487 is herein incorporated by reference in its entirety.

Co-pending U.S. provisional patent application 61/028,087, filed Feb. 12, 2008, and having attorney docket number TH3498 discloses a system comprising a structure; a long fairing comprising a chord to thickness ratio of at least about 1.7; and a short fairing comprising a chord to thickness ratio less than about 1.7. U.S. provisional patent application 61/028,087 is herein incorporated by reference in its entirety.

There are needs in the art for one or more of the following: apparatus and methods for reducing VIV and/or drag on structures in flowing fluid environments, which do not suffer from certain disadvantages of the prior art apparatus and methods; low drag devices; high stability devices; devices which delay the separation of the boundary layer, which cause decreased drag, and/or decreased VIV; devices suitable for use at a variety of fluid flow velocities; and/or devices that have a low drag and high stability, and/or systems and methods of selecting the optimal arrangements of devices to suppress VIV with the lowest total capital and maintenance costs.

These and other needs in the art will become apparent to those of skill in the art upon review of this specification, including its drawings and claims.

### SUMMARY OF THE INVENTION

Another aspect of the invention provides a method for determining a vortex induced vibration (VIV) suppression device configuration for a structure, comprising determining one or more technical parameters of the structure; determining VIV suppression performance for at least 2 different VIV suppression devices; determining installation and manufacturing or purchase costs of the at least 2 different VIV suppression devices; determining future costs for the at least 2 different VIV suppression devices; calculating total costs for the at least 2 different VIV suppression devices; and selecting a device with the lowest total costs that meets a desired level of VIV suppression for the technical parameters.

Advantages of the invention may include one or more of the following: improved VIV reduction; improved drag reduction; improved device stability; lower cost devices, lower maintenance costs, and/or lower total costs for VIV suppression.

These and other aspects of the invention will become apparent to those of skill in the art upon review of this specification, including its drawings and claims.

### BRIEF DESCRIPTION OF THE DRAWINGS

FIG. 1 shows a method for selection of optimal suppression devices.

FIG. 2 shows suppression devices installed about a structure.

FIG. 3 shows suppression devices installed about a structure.

FIG. 4 shows suppression devices installed about a structure.

### DETAILED DESCRIPTION OF THE INVENTION

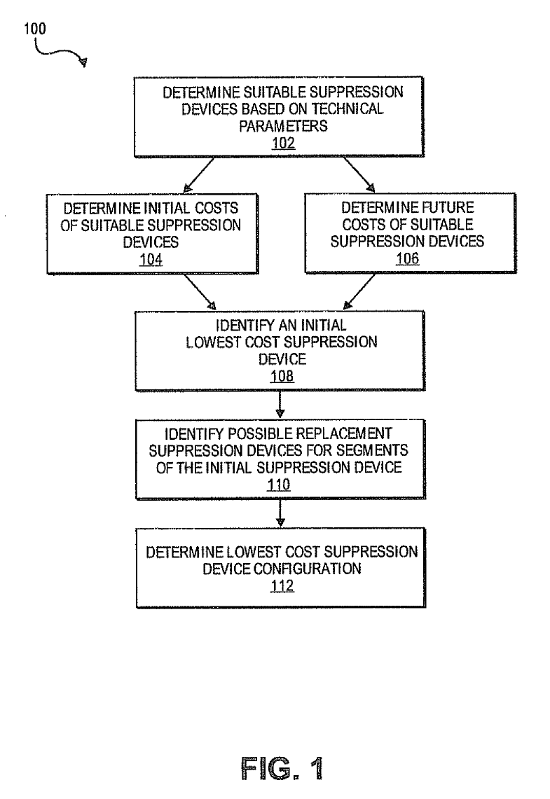

Referring now to FIG. 1, a method for selection of optimal suppression devices for suppressing vortex induced vibration (VIV) of a structure is disclosed. The terms “suppression device” and “suppression devices” as used herein generally refer to any device or combination of devices suitable for attaching to a structure (e.g. a deep sea tubular) for reducing drag and/or VIV of the structure. Representatively, suppression devices may include, but are not limited to, tall fairings, short fairings, tall strakes, short strakes, sleeves and multiple sided suppression devices.

Fairings may be defined by a chord to thickness ratio, where longer fairings have a higher ratio than shorter fairings. The chord may be measured from the front of the fairing to the tail and thickness may be measured from one side of the fairing to the other. In this aspect, tall fairings (also referred to as long fairings) refer to fairings having a chord to thickness ratio of greater than about 1.5. Short fairings refer to fairings having a chord to thickness ratio of less than about 1.5.

Strakes may be defined by the height of their fin from the underlying tubular. In this aspect, tall strakes refer to strakes having a fin height of about 0.25 D (¼ of the tubular diameter) and short strakes refer to strakes having a fin height of about 0.1 D.

Sleeves refer to cylindrical suppression devices having a smooth surface which wrap around all or a portion of the circumference of an underlying tubular.

Multiple sided suppression devices refer to devices having three or more sides. Representatively, a multiple sided device may have a cross section in the shape of a polygon such as a triangle, square, rectangle or pentagon. Multiple sided devices may further include devices having a cylindrical shape with blades.

Typically, VIV suppression systems for deepwater tubulars use either tall strakes or short fairings. Although such a combination of suppression devices may meet the technical performance criteria for a given application, the costs associated with installation and maintenance of such systems may be high. Method 100 therefore provides a system for selection of suppression devices which takes into account various technical, installation, maintenance and economic considerations. In this aspect, a low cost suppression device configuration which still meets the desired performance criteria can be determined.

The optimal suppression device configuration is obtained by first determining suitable suppression devices based on technical parameters (block 102). Technical parameters may include parameters that affect VIV and are indicators of the ability of the suppression device to reduce VIV or drag of the desired structure. In some embodiments, technical parameters include, but are not limited to, Reynolds number, reduced velocity and root mean squared (RMS) displacements. Parameters may include environmental data including information on currents, waves and vessel motion, information relating to marine growth rate with depth as well as structural properties of the potential suppression devices (e.g. chord-to-thickness ratio and surface roughness) and tubulars to be covered by the suppression devices. In addition, coverage density of the suppression devices on the tubular may be considered.

Further technical parameters may include interference effects from adjacent tubulars on the performance of the suppression devices. It is recognized that most tubulars, with an adjacent tubular upstream, will experience some reduction in the effectiveness of their suppression devices. In some cases, the degradation can be substantial. In this aspect, interference effects may be an important consideration in the technical analysis.

Some or all of these parameters may be considered in connection with each of the various suppression devices to determine which devices would perform (e.g. suppress VIV) as desired. In this aspect, a VIV analysis may be run for each potential suppression device using any conventional VIV analysis model (e.g., SHEAR7, VIVA or VIVANA). The VIV analysis model may be combined with a finite element model for static stress and deflection computations to ensure the device meets the desired performance criteria.

Initial costs for each of the suppression devices found to perform as desired are further considered (block 104). Initial costs may include, but are not limited to, costs per suppression device segment and associated hardware costs, costs of any coatings or marine growth protection and fixed setup and installation costs. A segment may be a foot, joint or whatever is prudent for the device and/or tubular. Representative cost estimates per segment may be, for example, $100.00 per foot for tall strakes, $90.00 per foot for short strakes, $250.00 per foot for tall fairings, $130.00 per foot for short fairings and $60.00 per foot for sleeves. It is noted that the values disclosed herein are estimates and are provided only as exemplary values for the purpose of illustrating the optimization analysis.

Fixed costs may vary depending upon, for example, the technique used to install the devices. There are various techniques that may be used to install the suppression devices, some more expensive and time consuming than others. One type of installation technique is referred to as yard installation in which the suppression devices are installed on the tubular in a fabrication yard. The costs of yard installation are relatively small since specialized equipment needs are minimized and relatively cheap labor can be used. Another type of installation technique involves installation of the suppression devices about the tubular on a vessel. In some cases, the tubular with suppression devices thereon must be lowered from the vessel using a stinger (e.g. S-lay installation) while in others the tubular does not have to go over a stinger (e.g. the tubular comes off a reel or a J-lay tower). During S-lay installation, for example, the suppression devices are subjected to large forces as they pass over the stinger and rollers. Another installation option is to retrofit the suppression devices underwater using either divers or a remotely operated vehicle (ROV). Retrofitting, however, is often expensive and riskier than other techniques, particularly when divers are used. In comparison to pre-installations, the costs associated with retrofitting using ROVs are substantially higher and can be difficult in all but relatively mild sea states. ROV installation requires tooling to interface between the ROV and the suppression device. Development and testing of this tooling can add considerably to the overall retrofit project costs. In addition, the costs of renting an ROV, rigging, additional personnel and possible vessel costs must further be considered when estimating the cost of retrofit installation.

In one embodiment, representative fixed costs may be, for example using round numbers, $150,000.00 for tall strakes, $200,000.00 for short strakes, $350,000.00 for tall fairings, $200,000.00 for short fairings and $250,000.00 per foot for sleeves. In this aspect, considering, for example, an embodiment where there are two tubulars and tall strakes installed along 1200 feet of each tubular achieve the desired VIV suppression, the total estimated initial costs would be $390,000.00 (1200 feet×$100.00/foot×2 tubulars+$150,000.00 fixed cost). A similar calculation is done for each of the suppression devices determined by the VIV analysis model to achieve the desired VIV suppression.

Future costs of each suitable suppression device are further considered (block 106). Future costs include, for example, cleaning and maintenance costs that accrue over the life of the suppression device. Cleaning and maintenance costs may include vessel, ROV and manpower costs associated with cleaning and maintenance of the suppression devices. Thus, it is contemplated that a consideration of such costs may produce different results for the different platforms used. Representatively, one platform may have an available ROV for cleaning while another platform may need to mobilize a vessel resulting in higher cleaning costs.

Representative cleaning and maintenance costs for tall strakes may be, for example, about $30,000.00 per 100 linear feet every year in a heavy marine growth environment. Representative cleaning and maintenance costs for short strakes may be, for example, about $25,000.00 per 100 linear feet every eight months for the same area. Representative cleaning and maintenance costs for tall fairings may be, for example, about $35,000.00 per 100 linear feet every 30 years. In a moderate marine growth environment, representative cleaning and maintenance costs for short fairings in the same environment may be, for example, about $25,000.00 per 100 linear foot every 10 years and the replacement costs may be zero if they are not put in the top 150 feet of the tubular. Representative cleaning and maintenance costs for sleeves in moderate marine growth environments may be, for example, about $50,000.00 per 100 linear feet every 6 months.

It is noted that the frequency of the cleaning is an important factor in estimating future costs. For example, assume that the initial cost associated with the use of strakes is around $1 million and the initial cost for fairings is around $1.5 million and strakes in a relatively moderate marine growth environment require cleaning every two years whereas fairings in a relatively moderate to heavy marine growth environment require cleaning every five years. When the initial and future costs over the life of each device are compared, it is found that the overall life-cycle costs (which include cleaning costs) for the fairings are actually slightly lower than that of strakes. Thus, selecting a device which may be more expensive to install but requires less cleaning may be cheaper over the life of the device than a device which is less expensive up front.

It is further noted that marine growth reduction coatings may sometimes reduce this advantage but these coatings often add to the initial expense and can result in, for example, a strake system that is more expensive than a fairing system. For example, a system having an initial cost of $1 million with a coating that requires $400,000.00 to clean every two years and does not require cleaning to begin for eight years (e.g. coated strakes) may be more expensive long term than a system having an initial cost of $1.5 million that requires $200,000.00 for cleaning every 5 years (e.g. uncoated fairings). Nevertheless, for tubulars with a short service life, marine growth prevention coatings may provide advantages when used on strake systems.

Each of the above economic considerations may be input into a financial model to determine an initial lowest cost suppression device to be used over the tubular (block 108). Such a model may consider factors such as initial costs (e.g., hardware and installation) and future costs (e.g., cleaning and maintenance) associated with a suppression device. In addition to the initial costs and future costs, factors such as a discount rate, an inflation rate, system life, book depreciation, tax depreciation and corporate tax rate may be included in the calculation. Such financial models are well known in the accounting profession for consideration of factors such as these. For example, the present value of future costs can be determined and considered with initial costs. Additional considerations such as depreciation and tax advantages/disadvantages may also be considered.

Once the lowest cost initial suppression device used for the entire tubular is identified, iteration begins to determine if segments of the selected suppression device can be replaced with other suppression devices to reduce the total life-cycle cost. In particular, beginning with the initial lowest cost suppression device identified in block 108 and using the segment length, all possible segment replacements are identified (block 110). Possible segment replacements may include suppression devices that do not meet the desired performance criteria (technical requirements) when used alone and therefore must be combined with other devices to fulfill the requirements.

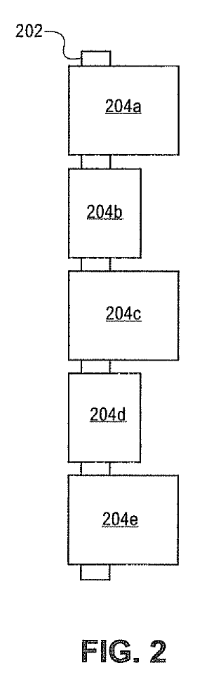

Representatively, in one embodiment, it may be found that the lowest cost initial suppression device is tall fairings positioned along 900 feet of the tubular. Some of the tall fairings are then replaced with other types of suppression devices to come up with different suppression device configurations. For example, every other tall fairing may be replaced with a short fairing as illustrated in FIG. 2. In this aspect, tall fairings 204a, 204c, and 204e, are alternated with short fairings 204b and 204d along structure 202 (e.g. tubular). Short fairings 204b and 204d may be lower in cost than tall fairings 204a, 204c, and 204e, and/or may act to reduce correlation of vortices between adjacent tall fairings. Tall fairings 204a, 204c and 204e may be substantially similar as those disclosed in U.S. Provisional Patent Application No. 61/028,087 and PCT Application PCT/US2007/084918, both of which are herein incorporated by reference in their entirety. Short fairings 204b and 204d may be substantially the same as those disclosed in U.S. Pat. No. 6,223,672 incorporated by reference in its entirety.

Although alternating short and tall fairings are illustrated in FIG. 2, it is contemplated that possible suppression device configurations may include any combination of fairings, strakes, sleeves, multiple sided suppression devices, or other devices, and any variation of those devices (e.g. with and without marine growth protection, etc.).

Representatively, other configurations may include short fairings in the high wave zone (near the water surface) replaced with strakes. In another embodiment, short fairings below the marine growth zone may be replaced with sleeves or multiple sided suppression devices.

The different device combinations are then analyzed and compared using the technical, installation, maintenance and economic considerations previously discussed to determine which configuration achieves the desired performance level at the lowest cost (block 112).

While all possible device combinations across each and every segment may be iterated to determine the optimal configuration, it is contemplated that the computations can be greatly reduced by identifying trends that do not meet the performance criteria or increase cost so that such undesirable configurations can be abandoned without further analysis.

In some embodiments, constraints may be factored into the analysis. Constraints may include a consideration of drag such that devices imposing too much drag would not be an option for fully covering the tubular (or combinations of devices that impose too much drag would not be an option). In other embodiments, the constraint may be that only fixed devices (e.g. strakes) are allowed along the top portion of the tubular due to wave forces. In still further embodiments, the constraint may be a philosophical constraint such as a requirement that devices that need to move to be effective (e.g. fairings or multiple sided devices) or that require frequent cleaning are not to be considered.

It is further contemplated that in some embodiments, risks and costs associated with those risks may be factored into the analysis. It is imperative that a sufficient coverage of suppression devices is initially installed and that the devices stay on the tubular to avoid costly retrofit. Thus, representative risks that may be factored into the analysis include the cost of retrofitting devices, the cost of device failure, the risk of ROV unavailability for cleaning, the risk of changes in environmental criteria, the risk of desired changes in device performance levels, the risk of inadequate performance of the devices, the risk of device structural failures, etc.

In still further embodiments, variations of the suppression devices may be considered. Representatively, copper and non-copper coated suppression devices may be considered separately.

Safety may also be considered in the analysis. Cleaning operations can add to the safety risks for personnel performing the cleaning operations. Thus, increased cleaning frequency further increases the safety risks.

The following examples illustrate representative results for selection of suppression devices using the method disclosed herein.

### EXAMPLE I

In one embodiment, the analysis to determine an initial lowest cost suppression device includes a consideration of Gulf of Mexico (GOM) environmental conditions. Such conditions include high potential waves, loop currents that can extend 1000 feet below the surface with surface currents up to 4 knots and moderate to low vessel motions for a tension leg platform (TLP). The analysis further takes into account that marine growth is moderate along the top 500 feet of the tubular and very small from a depth of about 500 to 800 feet. The analysis further takes into account that the suppression devices are to be installed about two 14 inch top tensioned risers.

The VIV analysis is run using any conventional VIV analysis model (e.g. SHEAR7, VIVA or VIVANA) to determine the length of the riser and suitable VIV suppression device for covering the riser length which will sufficiently suppress VIV. Upon running the VIV analysis, it is determined that only tall strakes covering 1200 feet per riser, short fairings covering 900 feet per riser and tall fairings covering 800 feet per riser will sufficiently suppress VIV to an acceptable level if used alone.

The estimated initial costs for tall strakes, short fairings and tall fairings are as follows: tall strakes are $100.00 per foot; short fairings are $130.00 per foot; and tall fairings are $250.00 per foot. In addition, the estimated initial costs for short strakes and sleeves are as follows: short strakes are $90.00 per foot; and smooth sleeves are $60.00 per foot.

The estimated fixed suppression costs (e.g. tooling, etc.) for tall strakes, short fairings and tall fairings are as follows: $200,000.00 for tall strakes; $200,000.00 for short fairings; and $350,000.00 for tall fairings. The estimated fixed costs for short strakes and sleeves are as follows: $200,000.00 for short strakes; and $250,000.00 for sleeves.

The initial costs associated with each of the devices found to sufficiently suppress VIV are then compared to determine the lowest cost suppression device that will sufficiently suppress VIV if used alone. As previously discussed, only tall strakes (1200 feet per riser), short fairings (900 feet per riser) and tall fairings (800 feet per riser) will sufficiently suppress VIV if used alone. Thus, only the total capital expenditure (capex) costs for these suppression devices are calculated. The total capex cost for each of the above suppression device options are as follows:

a) tall strakes

(1200 ft×$100/ft×2 risers+$150K fixed cost)=$390K

b) short fairings

(900 ft×$130/ft×2 risers+$200K fixed cost)=$434K

c) tall fairings

(700 ft×$250/ft×2 risers+$350K fixed cost)=$700K

It can be seen that when only the technical considerations and initial costs associated with the suitable suppression devices are considered, it appears that tall strakes are the lowest cost suppression device. The analysis, however, does not end here. Rather, total life-cycle costs for each device are calculated.

In this example, total life-cycle costs are calculated by adding in future costs such as cleaning costs for each device. Representatively, the estimated cleaning cost of tall strakes is $30,000.00 per 100 linear feet every year in the marine growth area, short fairings cost $25,000.00 per 100 linear feet every 10 years and the top portion of the short fairings must be replaced every 10 years due to wave forces at a cost of $100,000.00 and tall fairings cost $35,000.00 per 100 linear feet every 30 years. Although not used in this step it is further noted that the estimated cleaning costs for short strakes may be about $25,000.00 per 100 linear feet every 8 months and for sleeves may be about $50,000.00 per 100 linear feet every 6 months.

The estimated total life-cycle cost for each of the suitable devices (i.e., tall strakes, short fairings and tall fairings) may then be, for example, $650,000.00 for tall strakes, $575,000.00 for short fairings and $625,000.00 for tall fairings.

As is illustrated by the above considerations, a full economic analysis finds that long term, short fairings provide the lowest cost suppression device. In this aspect, it can be seen that the final cost preference is different from an analysis considering only initial device costs due to variations in cleaning cost.

Once the lowest cost initial suppression device used for the entire tubular is identified, iteration begins to see if segments of other devices can replace segments of the selected suppression device to reduce the total life-cycle cost. During the iterations, it is found that when segments of strakes are substituted for fairings in the high wave zone (near the surface), the life-cycle cost decreases because no replacements are needed (due to waves knocking fairings off of the riser). It is further found that smooth sleeves are the cheapest option per foot below 800 feet since they need no cleaning below that depth, but for 2 risers their tooling cost cannot be justified. In addition, it is found that strakes are cheaper than fairings below 800 feet. Since strakes have a strong economic benefit near the surface too, they may be justified at that region. Thus, after iteration, the lowest cost configuration is 200 feet of tall strakes at the top of the riser, 600 feet of short fairings below the top strake sections, 200 feet of tall strakes below the fairings for 1000 feet of total suppression about the tubular. This configuration substantially reduces cleaning costs at the expense of some additional tooling for a total life-cycle cost of $550,000.00.

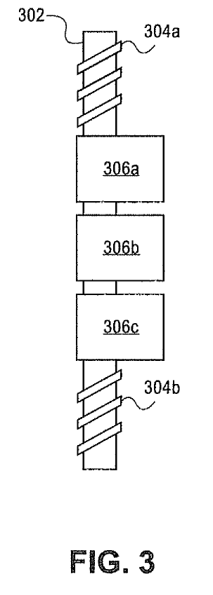

This configuration of Example I is illustrated in FIG. 3. Referring to FIG. 3, a suppression device configuration including fairings and strakes is illustrated. Fairings 306a, 306b and 306c and strakes 304a and 304b are installed about structure 302. Fairings 306a, 306b and 306c may be short fairings such as those described in U.S. Pat. No. 6,223,672 incorporated by reference in its entirety. Strakes 304a and 304b may be tall strakes helically wrapped around the tubular such as those disclosed in co-pending U.S. patent application Ser. No. 11/419,964, which was published as U.S. Patent Publication No. 2006/0280559, and incorporated by reference in its entirety.

### EXAMPLE II

In Example II, the inputs are the same as for Example I, except that suppression is for catenary risers that begin 100 feet below the surface and there are six risers instead of two.

Using the conventional VIV analysis model previously discussed, it is determined that tall strakes (1600 feet per riser), short fairings (1200 feet per riser but beginning at −150 feet), tall fairings (1000 feet per riser beginning at −150 ft), short strakes (1800 feet per riser) and smooth sleeves (2200 feet per riser) will all sufficiently suppress VIV to an acceptable level if used alone.

The total capex cost for each option is calculated as follows:

a) tall strakes

(1600 ft×$100/ft×6 risers+$200K fixed cost)=$1,160,000.00

b) short fairings

(1200 ft×$130/ft×6 risers+$200K fixed cost)=$1,136,000.00

c) tall fairings

(1000 ft×$250/ft×6 risers+$350K fixed cost)=$1,850,000.00

d) short strakes

(1800 ft×$90/ft×6 risers+$200K)=$1,172,000.00

e) smooth sleeves

(2200 ft×$60/ft×6 risers+$250K)=$1,042,000.00

Upon considering only the technical parameters and initial costs for each suppression device, smooth sleeves appear to be the lowest cost devices suitable for use alone along the riser.

Next, total life-cycle costs for each device are calculated. As previously discussed, total life-cycle costs are calculated by adding in future costs such as cleaning costs for each device. Representatively, the estimated cleaning cost of tall strakes, tall fairings, short strakes and sleeves are the same as those previously discussed. In this example, however, the estimated cleaning costs of short fairings are $25,000.00 per 100 linear feet every 10 years with zero replacement costs since they are not put in the top 150 feet of the tubular.

The estimated total life-cycle cost for each of the suitable devices (i.e., tall strakes, short strakes, short fairings, tall fairings and sleeves) are as follows:

a) tall strakes=$1,600,000.00

b) short fairings=$1,425,000.00

c) tall fairings=$1,650,000.00

d) short strakes=$1,880,000.00

e) smooth sleeves=$2,200,000.00

According to the above estimates, short fairings provide the lowest life-cycle cost when used over the entire riser.

Other suppression devices are then substituted for some of the fairing segments and the configurations are analyzed to determine if the life-cycle cost can be reduced. Substituting other devices for short fairings on the top segments does not lower the cost due to their cleaning cost or capex costs (fixed and per foot). Below about 800 feet however, smooth sleeves are substantially lower in cost and do not require cleaning below this depth. And not as many are needed since fairings are already providing a lot of damping. So the final lowest cost configuration is determined to be short fairings along the top 800 feet of the tubular with the remaining 500 feet of the tubular covered with smooth sleeves. The total life-cycle cost of this suppression device configuration is estimated to be about $1,240,000.00.

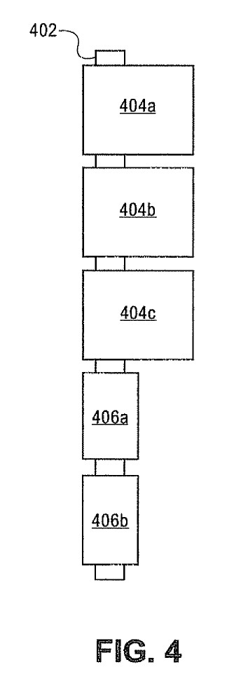

The configuration of Example II is illustrated in FIG. 4. Referring to FIG. 4, an optimal suppression device configuration includes a combination of fairings and a sleeve. Fairings 404a, 404b and 404c and sleeves 406a and 406b are installed about structure 402. Fairings 404a, 404b and 404c may be short fairings such as those previously discussed in reference to FIG. 3.

Sleeves 406a and 406b may be smooth sleeves as described in U.S. Pat. No. 7,017,666, herein incorporated herein in its entirety by reference. In some embodiments, sleeves 406a and 406b may be made of gel-coated fiberglass, copper (when marine growth inhibition is required), carbon fiber, rubber or any sufficiently smooth thermoplastic, metal alloy or other material. In still further embodiments, a smooth sleeve surface may be obtained by a surface finish on an outside of structure 402 or maintained by an ablative paint or other coating applied to the surface of structure 402. Sleeves 406a and 406b may have any dimension suitable for mounting sleeve 406 to structure 402 in combination with fairings 404a, 404b and 404c.

Although the lowest cost suppression device configurations arrived at in Examples I and II include combinations of fairings and strakes (Example I) and fairings and sleeves (Example II), it is contemplated that other combinations may provide another suitable low cost device configuration. Representatively, if the suppression devices are used in an environment having a very low marine growth profile (e.g. a pipeline span), then short strakes, smooth sleeves, or some combination may be more predominant in the final selection. In addition, if the required suppression length is sufficiently short, or if the number of tubulars is very small, it may be most economical to use a single device for the suppression provided it meets the desired technical requirements. Still further, if the technical requirements favor devices with very low drag, then tall fairings or smooth sleeves may be more predominant in the final selection.

By iterating through the above discussed steps, optimal configurations may be identified that meet desired technical requirements and minimize overall life-cycle costs.

The above described method for optimization of suppression devices can be implemented as computer readable codes in a computer readable recording medium. The computer readable recording medium includes various types of recording medium into which data that can be read by a computer system are stored. Examples of the computer readable recording medium are ROM, RAM, CD-ROM, DVD, Blu-Raym, magnetic tapes, floppy disks and optical data storing devices. Also, codes which can be read by the computer based on a distribution mode are stored into the computer readable recording medium distributed within a computer system connected via a network and can also be executed.

The VIV systems disclosed herein may be used in any flowing fluid environment in which the structural integrity of the system can be maintained. The term, “flowing-fluid” is defined here to include but not be limited to any fluid, gas, or any combination of fluids, gases, or mixture of one or more fluids with one or more gases, specific non-limiting examples of which include fresh water, salt water, air, liquid hydrocarbons, a solution, or any combination of one or more of the foregoing. The flowing-fluid may be “aquatic,” meaning the flowing-fluid comprises water, and may comprise seawater or fresh water, or may comprise a mixture of fresh water and seawater.

In some embodiments, suppression devices may be used with most any type of offshore structure, for example, bottom supported and vertically moored structures, such as for example, fixed platforms, compliant towers, tension leg platforms, and mini-tension leg platforms, and also include floating production and sub sea systems, such as for example, spar platforms, floating production systems, floating production storage and offloading, and sub sea systems.

In some embodiments, suppression devices may be attached to marine structures such as sub sea pipelines; drilling, production, import and export risers; water injection or import risers; tendons for tension leg platforms; legs for traditional fixed and for compliant platforms; space-frame members for platforms; cables; umbilicals; mooring elements for deepwater platforms; and the hull and/or column structure for TLPs and for spar type structures. In some embodiments, suppression devices may be attached to spars, risers, tethers, and/or mooring lines.

In some embodiments, the suppression devices may be placed on a marine structure after it is in place, for example, suspended between a platform and the ocean floor, in which divers or submersible vehicles may be used to fasten the multiple fairings around the structure. Alternatively, suppression devices may be fastened to the structure as lengths of the structure are assembled. This method of installation may be performed on a specially designed vessel, such as an S-Lay or J-Lay barge, that may have a declining ramp, positioned along a side of the vessel and descending below the ocean's surface, that may be equipped with rollers. As the lengths of the structure are fitted together, suppression devices may be attached to the connected sections before they are lowered into the ocean.

In some embodiments, fairings may be configured as tail fairings, for example as described and illustrated in co-pending U.S. application Ser. No. 10/839,781, which was published as U.S. Patent Application Publication 2006/0021560, and is herein incorporated by reference in its entirety.

In some embodiments, the fairings may include one or more wake splitter plates. In some embodiments, fairings may include one or more stabilizer fins.

While the suppression devices have been described as being used in aquatic environments, they may also be used for VIV and/or drag reduction on elongated structures in atmospheric environments.

### ILLUSTRATIVE EMBODIMENTS

In one embodiment, there is disclosed a method for determining a vortex induced vibration (VIV) suppression device configuration for a structure, comprising determining one or more technical parameters of the structure; determining VIV suppression performance for at least 2 different VIV suppression devices; determining installation and manufacturing or purchase costs of the at least 2 different VIV suppression devices; determining future costs for the at least 2 different VIV suppression devices; calculating total costs for the at least 2 different VIV suppression devices; and selecting a device with the lowest total costs that meets a desired level of VIV suppression for the technical parameters. In some embodiments, the technical parameters comprise at least one of Reynolds numbers, displacement, currents, waves, and marine growth rates. In some embodiments, the future costs comprise at least one of cleaning costs, maintenance costs, replacement costs, and operational costs. In some embodiments, the method also includes replacing at least a portion of the selected devices with a lower cost device. In some embodiments, the method also includes determining a VIV suppression performance of the remaining selected device and the lower cost devices. In some embodiments, tall fairings are replaced with short fairings. In some embodiments, strakes are replaced with sleeves. In some embodiments, the method also includes iterating VIV suppression performance and replacing additional selected devices with more lower cost devices until a minimum desired VIV suppression performance and a lowest total cost is reached.

While the illustrative embodiments of the invention have been described with particularity, it will be understood that various other modifications will be apparent to and can be readily made by those skilled in the art without departing from the spirit and scope of the invention. Accordingly, it is not intended that the scope of the claims appended hereto be limited to the examples and descriptions set forth herein but rather that the claims be construed as encompassing all the features of patentable novelty which reside in the invention, including all features which would be treated as equivalents thereof by those skilled in the art to which this invention pertains.

We claim:

1. A method for determining a vortex induced vibration (VIV) suppression device configuration for a structure, comprising:
determining one or more technical parameters of the structure;
determining VIV suppression performance for at least 2 different VIV suppression devices;
determining installation and manufacturing or purchase costs of the at least 2 different VIV suppression devices;
determining future costs for the at least 2 different VIV suppression devices;
calculating total costs for the at least 2 different VIV suppression devices; and
selecting a device with the lowest total costs that meets a desired level of VIV suppression for the technical parameters.

2. The method of claim 1, wherein the technical parameters comprise at least one of Reynolds numbers, displacement, currents, waves, and marine growth rates.

3. The method of claim 1, wherein the future costs comprise at least one of cleaning costs, maintenance costs, replacement costs, and operational costs.

4. The method of claim 1, further comprising replacing at least a portion of the selected devices with a lower cost device.

5. The method of claim 4, further comprising determining a VIV suppression performance of the remaining selected device and the lower cost devices.

6. The method of claim 4, wherein tall fairings are replaced with short fairings.

7. The method of claim 4, wherein strakes are replaced with sleeves.

8. The method of claim 5, further comprising iterating VIV suppression performance and replacing additional selected devices with more lower cost devices until a minimum desired VIV suppression performance and a lowest total cost is reached.
